(19) United States
(12) Patent Application Publication
(10) Pub. No.: US 2020/0269262 A1
(43) Pub. Date: Aug. 27, 2020

(54) EXHAUST AIR TEMPERATURE CONTROL SYSTEM

(71) Applicant: Saint Clair Systems, Romeo, MI (US)

(72) Inventor: Michael R. Bonner, Romeo, MI (US)

(21) Appl. No.: 16/801,743

(22) Filed: Feb. 26, 2020

Related U.S. Application Data
(60) Provisional application No. 62/810,596, filed on Feb. 26, 2019.

(51) Int. Cl. B05B 3/10; B05B 16/00; B05B 3/00

(52) U.S. Cl. CPC B05B 3/1035; B05B 3/001; B05B 3/1014; B05B 16/00

(57) ABSTRACT

A control system for devices driven by or utilizing decompressing air is provided. The system includes a supply of compressed air connected to a compressed air-utilizing device. A source of heated fluid is provided and is connected to a heat exchanger that transfers heat from the heated fluid to the compressed air. The compressed air is heated in the heat exchanger sufficiently that upon decompression the temperature of the device is not lowered to the ambient dew point. The system is particularly applicable to devices utilizing compressed air for the spraying of liquid materials

The present application is a U.S. Non-Provisional Utility Application claiming priority to U.S. Provisional Application 62/810,596 filed Feb. 26, 2019, the specification of which is incorporated by reference herein in its entirety.

### BACKGROUND

The present disclosure is directed to compressed air driven devices and more particularly to compressed air driven devices having air exhaust control systems.

Compressed air driven devices are important components in many assembly processes. For example, certain materials utilized in various work processes can contribute to increased explosion risks in some work environments. Similarly, the use of some materials and operating conditions can require modification of one or both of these parameters to mitigate explosion risks. A non-limiting example of this type of situation occurs in paint spraying operations as well as in other mixing and chemical operations. Such operations can produce flammable fumes and/or other suspended flammable material that creates hazards. In response to such hazards, industry has seen an increase in the use of compressed air to drive devices such as rotary disk sprayers in order to atomize paint for application.

However, the total performance of the respective compressed air driven device as well as the life span of such devices can be compromised do to the cooling effects that result from the expansion of the compressed air used to drive such compressed air devices. This can range from condensation of moisture from the surrounding environment to icing severe enough to stop operation of the compressed air device. To address this, in-line heaters are often used to heat the compressed air above the associated dew point.

Due to heater design constraints, in-line heaters are generally placed too far from the device to adequately compensate for the refrigeration effect. This can be due, at least in part, to the fact that the compressed air readily gives up its heat in the path between the inline heater and the application device. This is especially true when the pneumatic device is in an intrinsically safe area and the heater must be placed external to this area for safety reasons.

Robots, and the devices mounted on them, are expensive and must be protected, yet be accessible for service when required. The most common method employed to prevent the contamination of robots and the devices mounted on them from contamination such as paint overspray is to provide a flexible cover of either fabric or plastic. Such covers can do double duty, not only protecting the robot and devices from paint overspray and the like, but also preventing the leakage of air, oil, water, paint, solvent, and the like, from the robot into the paint environment which could negatively impact finish quality.

In certain coating application devices, compressed air is used both to atomize the coating material to be applied and to deliver the coating material to the target substrate. Coating application devices having devices such as bells and guns use compressed air for atomization of the coating material to be applied. The coating application devices also use compressed air as the shaping air that controls the dispensing pattern of the atomized coating material. Ambient air present during paint application operations typically has a relatively high humidity. When the compressed air delivered to the application device falls below the dew point of the ambient air in the booth, the resulting condensation is introduced directly into the paint application process, creating significant quality issues. While covers can assist in addressing the condensation and humidity issues, they cannot eliminate the problem entirely.

Various devices have been proposed that seek to control heat exchange temperature by regulating water temperature delivered to heat exchangers associated with the robot or other device. However, to date, no devices have been proposed that can provide a direct regulation of the actual temperature of the compressed air being employed. While regulation of the temperature of the robot or other device through indirect regulation may eliminate condensation issues under certain circumstances, it is difficult to adequately regulate the temperature of the compressed air itself and to adequately eliminate condensation issues.

Thus, it would be desirable to provide a method, system and coating application device that can regulate temperatures in a coating application environment in a manner that address and eliminates at least a portion of the condensation phenomena. It is also desirable to provide a device that can control and/or regulate the temperature of compressed air employed in applicator devices.

### SUMMARY

Disclosed is an apparatus for driving a device that includes a compressed air source and a device operable with air supplied from the compressed air source via a compressed air supply line. The device can also include at least one compressed air exhaust port; at least one sensor providing sensor output in communication with the compressed air supply line. The at least one sensor can be located proximate to the exhaust port. The apparatus also includes a heated fluid source for providing a heated fluid proximate to the at least one device operable by the delivered compressed air via a heated fluid supply line as well as a heat exchanger connected to the compressed air supply line and the heated fluid supply line and an electronic controller. The electronic controller is operable on the heat exchanger upon receipt of at least one output form the at least one sensor. The apparatus can also include a process fluid source and a process fluid supply line in communication with the process fluid source. The apparatus can also include at least one process fluid sensor that is in communication with the process fluid supply source and can be located in the process fluid supply line. The at least one at least one sensor provides a process fluid sensor output. The apparatus can conclude a process fluid temperature controller that can receive the process fluid sensor output, the process fluid temperature and provide output to the electronic controller such that the device operable with air supplied from the compressed air source includes at least one outlet in fluid communication with the process fluid supply line, at least one compressed gas outlet driving at least one movable component of the device and at least one compressed gas outlet.

### BRIEF DESCRIPTION OF THE DRAWINGS

The various features, advantages and other uses of the present apparatus will become more apparent by referring to the following detailed description and drawing in which:

FIG. 1A is a perspective view of a non-limiting example of a representative cover system present on the robotic arm of an associated applicator system that can be used with and embodiment of the method and apparatus as disclosed herein;

FIG. 1B is a perspective view of a non-limiting example of a representative cover system present on a portion of a paint delivery system used in associated applicator system that can be used with an embodiment of the method and apparatus as disclosed herein;

FIG. 1C is a perspective view of a non-limiting example of a representative cover system as employed in a representative paint spray booth that can be used with an embodiment of the method and apparatus as disclosed herein;

FIG. 2 is a temperature vs. time graph showing the relationship of temperatures of paint entering a paint spray booth, paint entering the bell of a compressed air driven paint spray device, booth ambient, and the compressed air exhaust into ambient air under an embodiment of a cover; and

FIG. 3 is a schematic diagram of an embodiment of a controls device as disclosed herein.

### DETAILED DESCRIPTION

Disclosed herein is control system, apparatus and method that can be employed with one or more various compressed air driven devices to control and/or condition the temperature of the compressed air that is employed in the operation and/or application of material such as paint and the like. Where desired or required, the compressed air temperature control system and method as disclosed herein can be employed with a coating applicator system. The present disclosure is also directed to a compressor air driven applicator device employing an embodiment of the controls system and device as disclosed herein.

It has been found, quite unexpectedly, that regulation of the temperature of compressed air delivered to a compressed air applicator device can provide improvements in the quality of the applied coating material. It has also been found that the method and device as disclosed herein, when employed in systems that include compressed air driven coating material applicators surrounded, at least in part by a protective coat or jacket can provide a climate-controlled robot arm apparatus.

A non-limiting example of a heat-controlled applicator device and system that relies on control of water temperature to the heat exchanger is U.S. Pat. No. 7,322,188 to Cline, the specification of which is incorporated by reference herein in its entirety. Such as system addresses and eliminates certain condensation issues by overheating the compressed air. In such systems, exhaust air is trapped under the protective cover surrounding the applicator. This creates an increase in temperature of the localized ambient air and in the temperature of the shaping air that can influence the temperature of the coating material to be applied. This can result in fluctuations in the viscosity of the coating material. However, if the temperature of the compressed air is not regulated, the environment under the cover as well as the shaping air could be significantly colder than the desired temperature for optimum coating material application.

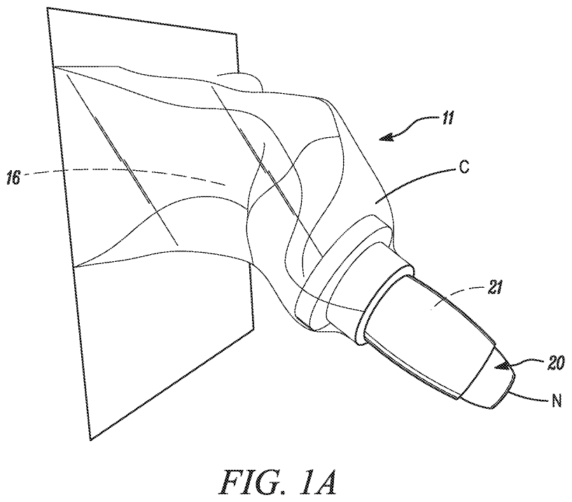

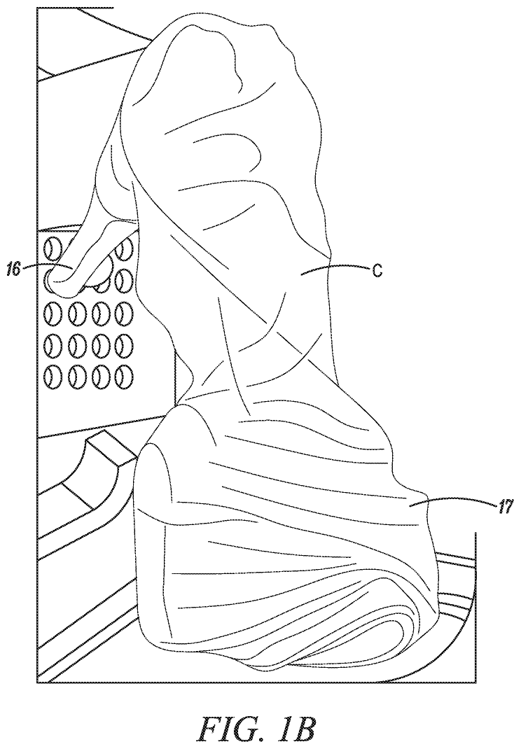

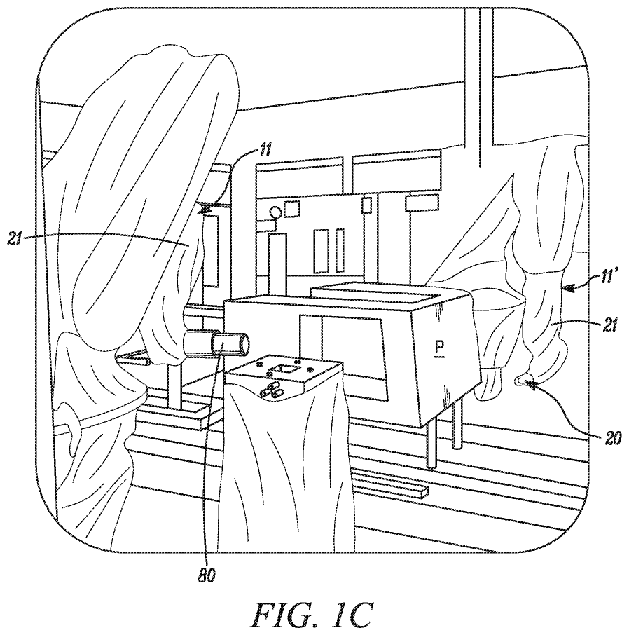

Various compressor air driven applicator devices can be employed in the method and device as disclosed herein. Non-limiting examples of suitable compressor driven air devices include coating applicator devices such as paint spray devices. The compressor air driven applicator device that can be employed with the controls system and device as disclosed herein can have various configurations, non-limiting examples of which are depicted in FIGS. 1A, 1B and 1C. Non-limiting examples of systems in which the exhaust air temperature control system can be employed include compressed air driven applicator systems that comprise an applicator 20 and a cover C. Where desired or required, the exhaust air temperature control system can also include at least one robotic arm mechanism such as robotic arm mechanism 16.

In the non-limiting example depicted in FIG. 1A, the air driven applicator system 11 can be configured as a robotic arm 16 that projects from a wall, barrier or suitable other suitable structure such as wall W. The air driven applicator device 11 can have a suitable cover C that overlies the central region of the robotic arm 16 and permits a suitable nozzle N in applicator 20 to protrude from a suitable opening defined in in cover C. In the embodiment depicted in FIG. 1A the applicator 20 can be configured and equipped to convey materials such as coating material like paint to a suitable substrate. In the embodiment illustrated in the FIG. 1C, the cover C extends from a location proximate to the orifice to a location proximate to or abutting the wall W. Where desired or required, the cover C can be configured in a manner the envelops the applicator 11 device in a manner that can include the applicator 20 and applicator housing. The applicator 20 can be configured to be movable relative to the wall W with movements triggered by a suitable controller or the like. The robotic arm can be movable as by suitable electronic actuation. Where desired or required, the cover C can be configured to include at least a portion of the robotic arm (not shown) to which the applicator is mounted.

In the non-limiting exemplary example illustrated in FIG. 1B, the applicator device 16 can include a mounting device such as robotic mounting device 17. The applicator device 16 and suitable portions of the mounting device 17 can be enveloped with a suitable cover C.

It is contemplated that multiple systems as disclosed herein can be employed in applications where multiple compressor air driven applicator systems 11, 11′ are positioned in locations such as a paint spray booth or the like. A non-limiting example of such an application is illustrated in FIG. 1C. The compressor air driven applicator systems 11, 11′ in FIG. 1C are located in generally apposed relations ship with a workpiece interposed between them. The compressor air driven applicator systems 11, 11′ each includes a suitable cover C that overlies the central region of the robotic arm 16 and permits a suitable nozzle N in applicator 20 to protrude from a suitable opening defined in in cover C. Each cover C can be configured to include at least a portion of the robotic arm (not shown) to which the applicator is mounted.

In the system 10 as disclosed herein, it is contemplated that compressed air that is employed in the coating device such as a compressed air drive applicator device can originate from any suitable source. The system 10 can be connected to the compressed air source by any suitable mechanism and can be conveyed to at least one heat exchanger located downstream of the compressed air source to condition the compressed air passing therethrough.

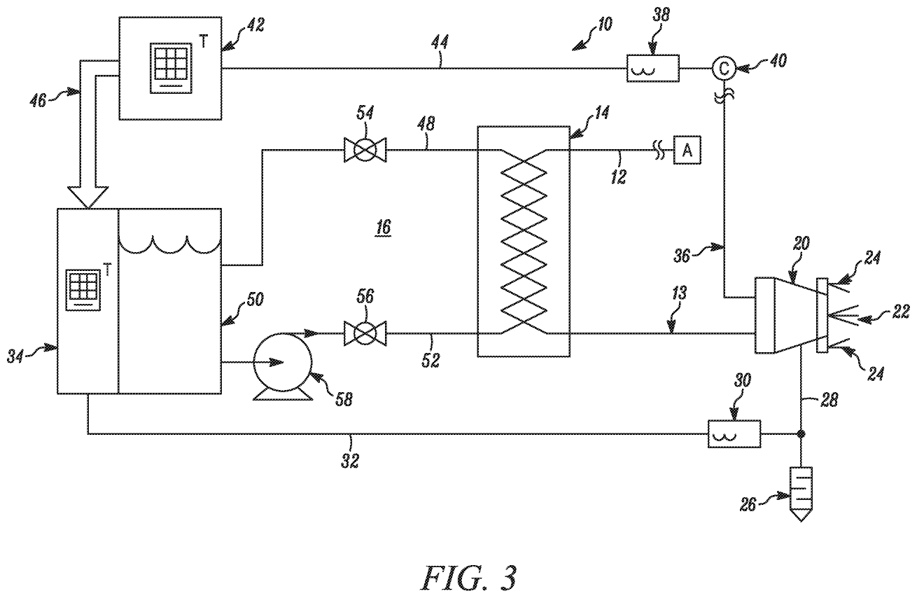

An illustrative embodiment of the system 10 disclosed herein is schematically depicted in FIG. 3 and be connected to a suitable source of compressed air A by a suitable coupler (not shown). The compressed air can be conveyed from the source of compressed air A through a suitable conduit such as compressor air line 12 to at least one suitable heat exchange unit 14. The compressor air line 12 can be composed of suitable piping or conduit having a first end proximate to the coupler and a second end opposed to the first end. The second end of the compressor air line 12 is connected to at least one suitable heat exchanger unit 14. Where desired or required, the system 10 can include two or more heat exchangers if needed. The heat exchanger unit(s) 14 located in contact with the compressor air line 12 are configured to condition the compressor air derived from compressed air source A before the compressed air exits the heat exchanger unit(s) 14 and enters into a suitable conduit to convey the conditioned compressed air is routed to a suitable compressed air driven applicator device, non-limiting examples of which have been illustrated previously. In the embodiment as illustrated in FIG. 3, the conditioned compressed air is conveyed from the exit of the heat exchange unit 14 via conditioned compressor air line 13.

The heat exchange unit 14 employed in the system 10 can be a device in which one or more lines carrying a thermal transfer fluid are in intimate thermal contact with one or more lines carrying compressed air. In various embodiments, it is contemplated that the thermal transfer fluid can be water or suitable organic materials. In various embodiments, it is contemplated that the thermal transfer fluid will be water or the like. As used herein the term “heat exchange unit” should be broadly construed. Various means for heating the compressed air supply could be used without departing from the scope of the present disclosure. It is also considered with in the purview of this disclosure that one or more heat exchange units 14 can be employed. Multiple heat exchange units can be positioned in series or in parallel relative to the compressed air supply line(s). Where desired or required, the at least one suitable heat exchange unit 14 can be mounted on the robotic arm unit 16 of an associated air driven applicator device 11.

The conditioned compressed air stream that is routed to the applicator 11 can serves multiple function. The conditioned compressed air can function to atomize the coating material to be applied in order to produce an atomized coating material stream such as atomized coating material stream 22 schematically depicted in FIG. 3. The conditioned compressed air can also function to provide shaping air 24 that surrounds the atomized coating material stream 22 as both exit orifice N. The shaping air 24 stream serves to direct the atomized coating stream 22 into position on the substrate to be coated. One such part is part P as depicted in FIG. 1C.

The system 10 as disclosed herein can be employed with various applicator assemblies that are used in the applicator 20. One non-limiting example of an applicator assembly suitable for use with the system and device disclosed is a rotary atomizer also referred to as a paint bell or a bell applicator. Without being bound to any theory, the bell applicator generally includes major assemblies such as a valve module, a bell cup, a turbine, and a shaping air shroud or ring. In certain rotary bell assemblies, the valve module can include passages for paint, solvent and compressed air as well as valves to control the flow of each of the items into the system for paint delivery as well as for purging and cleaning as desired or required and for management of compressed air to valves, the turbine and to the shaping air shroud.

In certain applicators, the bell cup can be configured as a conical disc that is fixed to the associated robot arm and communicates with the shaft of the turbine. Paint or coating material can be injected into the central rear of the disc to form a thin film at the bottom of the disc. Centrifugal force exerted due to disc rotation can pull the paint towards the edges of the cup where it breaks into atomized droplets.

The turbine can be configured as a high-speed air motor that rotates the bell cup at speeds at suitable to atomize the accumulated paint particles. Rotational speed can vary depending upon parameters including, but not limited to, the physical properties of the paint or coating material, the cup diameter, the degree of atomization desired and the like. In certain applications, rotational speeds between 10,000 rpm and 70,000 rpm may be employed.

The shaping air shroud or shaping air ring that produces shaping air stream 24 can be configured as a ring with a plurality of small passages such as pin holes positioned to permit outward air flow out the front of the atomizer at a location outside the bell cup diameter in order to control the size of the spray pattern produced. In general, as more air is pushed through the shaping air shroud, the atomized paint will be shaped into a smaller pattern.

In addition to the air associated with the atomized paint or coating material and the shaping air stream 24, a portion of the conditioned air also powers the turbine of the applicator. After powering the turbine, this portion of the conditioned air exits as exhaust gas. The exhaust air produced by the turbine exits from the turbine at a suitable exhaust port such as at muffler 26. In certain embodiments of system 10 as disclosed herein, the exhaust port such as muffler 26 can be located within the interior area defined by cover C. It is to be understood that the system 10 can include one or more exhaust paths and that the system 10 can include one or more other exhaust path(s) instead of or in addition to the muffler 26. The exhaust gas such as that produced by the turbine or other suitable applicator mechanism can be conveyed to the suitable exhaust port by means of one or more conduits such as conduit 28.

The system 10 as disclosed herein can also include includes at least one feedback sensor 30 that can be positioned proximate to the one or more conditioned compressed air exhaust path(s) such as muffler 26. The at least one feedback sensor 30 can be configured to monitor one or more parameters associated with the exhaust gas and convey data regarding the parameters monitored. In certain embodiments, at least one feedback sensor can be positioned so as to monitor temperature conditions within cover C. As depicted in FIG. 3, the at least one sensor feedback 30 is positioned in the exhaust gas flow path in communication with conduit 28. In certain embodiments, the feedback sensor 30 can be a device configured to determine the temperature of the exhaust gas. Non-limiting examples of temperature sensors include RTD, thermocouples, thermistors, IR detectors, etc. As depicted, the at least one feedback sensor 30 is located in conduit 28 at a location that is between the midpoint and the junction with muffler 26.

The data developed from the at least one feedback sensor 30 can be conveyed to a suitable controller such as an electronic controller 32 by any suitable means. In certain embodiments, the system 10 as disclosed herein can also include suitable relays and wiring 32 to communicate data and outputs generated by the at least one feedback sensor 30 to a suitable electronic controller 34. The electronic controller 34 that is employed in the system 10 receive the data generated from the at least one feedback sensor 30. The electronic controller 34 can also include suitable command logic to exert over mechanisms in order to control of the temperature of compressed air circulating in the system 10.

In embodiments of the system such as that depicted in FIG. 3, coating material to be applied is supplied to the applicator 20 by means of suitable material supply tubing such as coating material supply tubing 36. The condition of the coating material to be applied (such as coating material temperature) can be ascertained by at least one coating material sensor such as coating material temperature sensor 38. Where desired or required, the coating material conditions sensor such as coating material temperature sensor 38 can be operatively positioned in the coating material supply tubing 36.

The coating material to be applied can be a suitable fluid material that is supplied from a suitable supply source. In certain embodiments, it is contemplated that the coating material to be applied will have passed through a suitable temperature control system heat exchanger 40 prior to entry into material supply tubing 36. The at least one coating material temperature sensor 38 may one be of any common industrial type including, but not limited to, RTD, thermocouple, thermistor, IR detector, etc. The at least one temperature sensor 38 is in electronic communication with a suitable coating material temperature controller 42 by any suitable means including but not limited to hard wiring 44, Bluetooth and the like.

It is contemplated that the at least one coating material temperature sensor 38 can be associated with the coating material path in the material supply tubing 36 or in a thermal conditioning fluid path that may be associated with the thermal control system 40. Where the system includes more than one coating material temperature sensor, it is contemplated that coating material temperature sensors can be positioned in contact with the coating material path, the thermal conditioning fluid path or both. The measured coating material temperature value can be communicated to the coating material temperature controller 42 either continuously or at desired intervals.

In the system 10 as disclosed, coating material temperature data communicated to the coating temperature controller 42 can be evaluated against a coating set point programmed into the coating material temperature controller 42. This coating material set point, together with the measured coating material temperature data can be communicated to the air temperature controller 34 via a communications link 46. Non-limiting examples o a suitable communication link can include various communications platforms such as 4-20 mA, 1-5 VDC, 010 VDC, etc., or digital like RS-485, Ethernet, DeviceNet, CAN Bus, etc.

The system 10 as disclosed herein also includes a thermal transfer fluid loop that communicates between the heat exchanger 14 and the electronic controller 34 to regulate and control the temperature of the compressor air passing through the system 10. As depicted in FIG. 3, in addition to the heat exchanger 14, the thermal transfer fluid loop includes thermal transfer fluid conduit 48 conveying thermal transfer fluid to the thermal transfer fluid temperature reservoir 50 and thermal transfer fluid conduit 52 conveying thermal transfer fluid away from the thermal transfer fluid reservoir 50 that functions as an in line transfer fluid heater to the heat exchanger 14 in a generally continuous manner. The thermal fluid transfer loop can also include at least on suitable check valve. As depicted in FIG. 3, check valve 54 is located in thermal transfer fluid conduit 52 and check valve 56 is located in thermal transfer fluid check conduit 54.

The thermal transfer fluid loop can also include at least one thermal transfer fluid circulating pump 58. In the embodiment depicted din FIG. 3, the thermal transfer fluid circulating pump 58 is located in the thermal transfer fluid conduit 52.

The coating material temperature setpoint can be programmed into the coating temperature controller 42 by any suitable means. This setpoint can communicated to the electronic controller 34 of the air temperature control system via any common communication platform as at reference numeral 46. This set point is adopted by the electronic controller 34 as the air temperature setpoint and as the setpoint of the thermal transfer fluid circulated by pump 58 through heat exchanger 14. This value is manipulated to bring the exhaust temperature, as measured by the feedback sensor 30 to the coating material setpoint temperature. In this manner, exhaust air exiting muffler 26 and shaping air 24. This assures that the exhaust air exiting muffler 26 and shaping air 24 are held at the same temperature as the coating material delivered to the applicator via conduit 36 and applied to the part (not shown).

Without being bound to any theory, it is believed that controlling and coordinating the temperature of the coating material, shaping air, robot arm environment and delivery system components to provide a consistent temperature independent of changes in ambient temperature resulting from variations from day-to-night and season-to-season, the viscosity of the coating will be consistent and repeatable and the quality of the finish can be maintained.

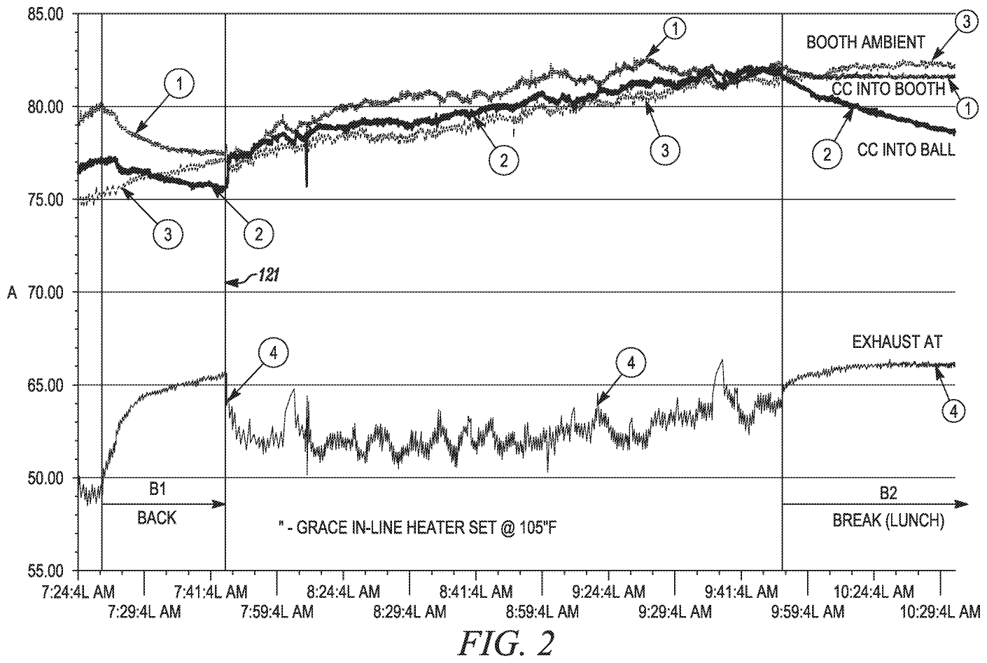

In order to further appreciate the system and device as disclosed herein, temperature readings associated with application of a representative clear coat material using a typical applicator system such as that illustrated schematically in FIG. 3 were collected and recorded. These data are presented graphically in FIG. 2 with time present on the X-axis and temperature recorded on the Y-axis. The graph compares temperature output and performance for a system that employs an inline heater located immediately outside the paint spray booth.

In line heater output is recorded as 105° F. Trace 1 shows the clearcoat temperature entering the paint spray booth and Trace 2 shows the clearcoat temperature as it enters the bell associated with the applicator unit. The ambient temperature value of the booth is recorded in Trace 3 is the booth ambient temperature value. Clearcoat temperature as it enters the booth is recorded as increasing toward 80° F. at time stamp 7:15 A. This is a full 25° F. below the in-line heater output of 105° F., and a good demonstration of why inline heaters located outside the booth are ineffective.

The clearcoat material that is delivered to the bell illustrated in Trace 2 tracked the incoming temperature with an offset of about 2.5° F. This would normally be attributed to the influence of booth ambient temperature on the coating material as it travels along the arm of the robot to the point of application.

When painting was stopped for a break at about 7:20 A, the paint was left sitting stationary in the system, the clearcoat material at the booth wall (Trace 1) temperature experiences temperature loss, nearly reaching booth ambient (Trace 3) by the end of the break B1. The clearcoat material at the bell inlet (Trace 2) however, continued to lose temperature, falling a full 2° F. below the booth ambient temperature (Trace 3) by the end of the break B1. This “sub-cooling” phenomena cannot be the result of booth ambient air. Therefore, it must originate from another source having a temperature below the temperature listed above. One such colder source is found in the exhaust air that is shown in the graph of FIG. 2 as Trace 4. This exhaust air hovered between 60° F.-65° F., barely exceeding 65° F. during the breaks when consumption is at its minimum.

If it is known at all, it is generally misinterpreted as booth ambient influence (Trace 3). When the lines were purged to restart painting at about 7:50 A, R1, the temperature of the clearcoat material into the booth (Trace 1) and the temperature of the clearcoat material at the bell inlet (Trace 2) come together and after which the bell inlet temperature (Trace 2) stays between the clearcoat inlet (Trace 1) and booth ambient (Trace 3) temperature over the next two hours of runtime. Considering that the clearcoat is flowing through Teflon tubing, which provides some level of insulation, and also factoring in the short dwell time in that tubing during continuous paint cycles, it is clear that the temperature differential (ΔT) between the clearcoat inlet temperature (Trace 1) and the booth ambient temperature (Trace 3) is insufficient to produce this drop in temperature.

From the perspective of process control and finish quality repeatability, the influence of this refrigerated air is not consistent. As shown in FIG. 2, it varied based on the time between racks (varying gaps), breaks, downtime, shutdowns, etc. It varied based on the rate of change, which is determined by the temperature differential (ΔT) between the coating temperature (Trace 1) and the refrigerated air temperature (Trace 4), both of which are a function of plant ambient temperature. Though not shown in FIG. 2, plant ambient temperature varies from morning-to-night and season-to-season. The refrigerated air temperature also varied based on the supply pressure and the flow rate, which can vary based on different parts being coated. These variations were made evident at the lunch break B2 starting about 9:55 A and continuing through the 10:30 A hour.

These variations were virtually invisible to the line operators and process engineers responsible for maintaining consistent process outcomes, which can make it very hard to identify them as the source of finish quality issues. This is especially true in this example depicted in FIG. 2, where the booth ambient temperature (Trace 3), probably the only temperature being measured, moves nearly 8° F. in just 3 hours.

In contrast, if the paint system is equipped with a temperature control system that is overheating, then the environment under the cover, and the shaping air, will be warmer than desired, and the opposite of the effect shown in FIG. 2 will be encountered. Either situation will result in the coating being applied at the wrong temperature and therefore the wrong viscosity, which will negatively affect the quality of the finish.

Without being bound to any theory, it is believed that the system and device as disclosed herein provides for a coating material application device that measures the exhaust air temperature and controls the air inlet temperature to match the exhaust air to the coating temperature setpoint in which the controls function as a slave to the coating temperature control system to assure that coating temperature, shaping air, and the contained environment under the robot cover are all controlled at the same temperature independent of changes in ambient related to morning-to-night and season-to-season variations.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for driving a device with compressed air comprising:
a compressed air source;
a device operable with air supplied from the compressed air source via a compressed air supply line, the device including at least one compressed air exhaust port;
at least one sensor in communication with the compressed air supply line, the at least one sensor located proximate to the exhaust port, the at least one sensor providing a sensor output;
a heated fluid source for providing a heated fluid proximate the at least one device via a heated fluid supply line;
a heat exchanger connected to the compressed air supply line and the, heated fluid supply line;
an electronic controller, the electronic controller operable on the heat exchanger upon receipt of at least one output form the at least one sensor;
a process fluid source;
a process fluid supply line in communication with the process fluid source;
at least one process fluid sensor in communication with the process fluid supply source, the at least one process fluid sensor located in the process fluid supply line, the at least one sensor providing a process fluid sensor output; and
a process fluid temperature controller, the process fluid temperature controller receiving the process fluid sensor output, the process fluid temperature controller providing output to the electronic controller;
wherein the device operable with air supplied from the compressed air source includes at least on outlet in fluid communication with the process fluid supply line, at least one compressed gas outlet driving at least one movable component of the device and at least one compressed gas nozzle.

2. The apparatus of claim 1 wherein the heat exchanger transfers heat energy from the heated fluid to the compressed air, thereby elevating the temperature of the air sufficiently that upon decompression and driving of the device the temperature of the air remains higher than an ambient dew point.

3. The apparatus of claim 1 wherein the temperature of the process fluid dispensed from the compressed air driven device and the compressed air dispensed from the at least one compressed gas nozzle are within 10° C. of one another.

4. The apparatus of claim 1 wherein the temperature of the process fluid dispensed from the compressed air driven device and the compressed air dispensed from the at least one compressed gas nozzle are within 1° C. of one another.

5. The apparatus of claim 1 wherein the compressed air driven device is a process fluid spray applicator, the spray applicator having a central atomizer outlet at least one compressed gas nozzle outlet peripheral to the central atomizer outlet.

6. The apparatus of claim 5 wherein the air driven device further includes at least one exhaust gas outlet, wherein the exhaust gas, the atomized process fluid and the gas exiting the gas exhaust nozzle have each have a temperature value with 10° of one another.

7. The apparatus of claim 6 further comprising a cover, the cover overlaying at least the exhaust gas outlet.

8. A system for the application of liquid materials to a substrate comprising:
a compressed air source;
an coating application booth;
a rotary device positioned in the application booth for atomizing and spraying a liquid material, wherein the rotary device is driven by decompressing air supplied from the compressed air source, the rotary device including at least one atmoziser and at least one shaping air generator;
at least one sensor in communication with the compressed air supply line, the at least one sensor located proximate to the exhaust port, the at least one sensor providing a sensor output;
a heated fluid source for providing a heated fluid proximate the at least one device via a heated fluid supply line;
a heat exchanger for heating the compressed air prior to driving the rotary device by transferring heat thereto from fluid supplied by the heated fluid source;
an electronic controller, the electronic controller operable on the heat exchanger upon receipt of at least one output form the at least one sensor;
a process fluid source;
a process fluid supply line in communication with the process fluid source;
at least one process fluid sensor in communication with the process fluid supply source, the at least one process fluid sensor located in the process fluid supply line, the at least one sensor providing a process fluid sensor output; and
a process fluid temperature controller, the process fluid temperature controller receiving the process fluid sensor output, the process fluid temperature controller providing output to the electronic controller;
wherein the device operable with air supplied from the compressed air source includes at least on outlet in fluid communication with the process fluid supply line, at least one compressed gas outlet driving at least one movable component of the device and at least one compressed gas nozzle.

9. The system of claim 8 wherein the liquid material supplied to the rotary device comprises a paint, and wherein the rotary device comprises a rotatable atomization disk driven by decompressing air, the rotary device being mounted in a painting bell.

10. A method of controlling coating composition quality in a liquid spraying apparatus comprising the steps of:
connecting a compressed air supply line with a device at which air is decompressed;
connecting the compressed air supply line to a heat exchanger and passing compressed air therethrough;
connecting a supply line carrying heated fluid to the heat exchanger such that the heated fluid can elevate the temperature of the compressed air in the heat exchanger;
supplying the compressed air passed through the heat exchanger to the device.
